(19) United States
(12) Patent Application Publication
(10) Pub. No.: US 2018/0025378 A1
(43) Pub. Date: Jan. 25, 2018

(54) Fatigue Control in Dissemination of Digital Marketing Content

(71) Applicant: Adobe Systems Incorporated, San Jose, CA (US)

(72) Inventors: Moumita Sinha, Bangalore (IN); Harvineet Singh, Bengaluru (IN); Véronique Fabienne Gaudrat, Paris (FR); Philippe Ferdinand, Boston, MA (US)

(73) Assignee: Adobe Systems Incorporated, San Jose, CA (US)

(21) Appl. No.: 15/216,360

(22) Filed: Jul. 21, 2016

(51) Int. Cl. G06Q 30/02

(52) U.S. Cl. CPC G06Q 30/0244; G06Q 30/0264; G06Q 30/0246

(57) ABSTRACT

Fatigue control techniques are described as part of dissemination of digital marketing content. In one example, a model is trained on marketing data using machine learning. The marketing data describes user interactions with digital marketing content. An indication is also received of a subsequent user that is to receive the digital marketing content. User interaction data is obtained that describes prior digital marketing content interactions of the subsequent user. The user interact data, for instance, may have features that are similar to features of the marketing data used to train the model. A score is generated using the model from the user interaction data. the score is indicative of likely receptiveness of the user to receipt of the digital marketing content. Dissemination is controlled of the digital marketing content to the user based at least in part on the score.

### BACKGROUND

Digital marketing content is typically provided to users in order to increase a likelihood that a user will interact with the content or another item of digital marketing content toward purchase of a product or service, which is also referred to as conversion. In one example of use of digital marketing content and conversion, a user may navigate through webpages of a website of a service provider. During this navigation, the user is exposed to advertisements relating to the good or service. If the advertisements are of interest to the user, the user may select the advertisement to navigate to webpages that contain more information about the product or service that is a subject of the advertisement, functionality usable to purchase the good or service, and so forth. Each of these selections thus involves conversion of interaction of the user with respective digital marketing content into other interactions with other digital marketing content and/or even purchase of the good or service.

In another example of digital marketing content and conversion, users may agree to receive emails or other electronic messages relating to goods or services provided by the service provider. The user, for instance, may opt-in to receive emails of marketing campaigns corresponding to a particular brand of product or service. Likewise, success in conversion of the users towards the product or service that is a subject of the emails directly depends on interaction of the users with the emails.

Marketers, as part of a desire to increase a likelihood of conversion, may expose users to a multitude of digital marketing content. However, this may cause the users to become fatigued by this exposure over time and thus decrease a likelihood of conversion by the users. For example, users may feel pressured by repeated exposure to digital marketing content from a brand, e.g., a shoe company. As a result, the user may reach a state of fatigue in which the user chooses to forgo receipt of additional digital marketing content from that brand. The user, for instance, may unsubscribe to prevent further receipt of the digital marketing content from a marketer of that brand, mark the digital marketing content as “spam,” and so forth. This removes any further ability of a marketer to further engage this user using digital marketing content.

### SUMMARY

Fatigue control techniques are described as part of dissemination of digital marketing content. In one example, a machine learning model is trained using marketing data. The marketing data describes user interactions with digital marketing content, e.g., features of user interactions such as “clicks,” how many times items of digital marketing are exposed to users, a number of times the users have visited the un-subscription page in order to unsubscribe to digital marketing content, and so forth.

An indication is also received of a subsequent user that is to receive the digital marketing content, such as from interaction of a marketer with a user interface, selection of a subset of users from a pool of users that are to receive digital marketing content, and so forth. User interaction data is then obtained that describes prior digital marketing content interactions of the subsequent user. The user interaction data, for instance, may include features that are similar to features of the marketing data used to train the model as described above.

A score is generated by processing the user interaction data using the model. The score is indicative of likely receptiveness of the user to receipt of the digital marketing content. The score, for instance, may be used to assign the user to a fatigued segment in which the user is not receptive at this point in time to receipt of items of digital marketing content. The score may also be used to assign the user to an active segment in which the user is receptive to receipt of items of digital marketing content. Other segments are also contemplated, such as an “at risk” segment in which the user is currently receptive to receipt of digital marketing content, but is in danger of becoming fatigued.

In some instances, the generated score is used to control dissemination of the digital marketing content to the user. Continuing with the segmentation example, a number of items of the digital marketing content may be determined that is likely to cause the subsequent user, after receipt of this content, to remain in the active or at risk segment. Similarly, the number of items of the digital marketing content may be determined that is likely to cause the subsequent user in the fatigued segment to transition to the active or at risk segments. In this way, dissemination techniques, which controls how digital marketing content is disseminated or provided to users, may be employed to reduce a likelihood of users becoming fatigued, and even cure users that are fatigued but have not yet unsubscribed (i.e., “at risk” users).

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. The use of the same reference numbers in different instances in the description and the figures may indicate similar or identical items.

FIG. 1 is an illustration of an environment in an example implementation that is operable to employ digital marketing content dissemination techniques described herein.

FIG. 2 depicts a system in an example implementation showing a fatigue management system of FIG. 1 in greater detail.

FIG. 3 depicts a system in an example embodiment showing operation of a scoring module of FIG. 2 in greater detail.

FIG. 4 depicts as system in an example implementation showing operation of a digital marketing content dissemination module of FIG. 2 in greater detail.

FIG. 5 depicts an example of a user interface output by the fatigue management system of FIG. 2.

FIG. 6 is a flow diagram depicting a procedure in an example implementation in which dissemination control techniques of digital marketing content address potential user fatigue.

FIG. 7 illustrates an example system including various components of an example device that can be implemented as any type of computing device as described and/or utilized with reference to FIGS. 1-6 to implement embodiments of the techniques described herein.

### DETAILED DESCRIPTION

Overview

Digital marketers employ a variety of insights about activities of existing and potential consumers in order to understand the performance of digital marketing content provided to the consumers. In this way, the digital marketers may employ digital systems to control dissemination of subsequent items of digital marketing content to increase a likelihood that the digital marketing content is of interest to these consumers. One such insight is to control dissemination of the digital marketing content to avoid user fatigue (e.g., strategic delivery of electronic mail, text messages, and other digital marketing content to client devices for viewing by user). Fatigue is defined as a user state, once reached by the user, that the user is in danger of potentially attempting to actively avoid further exposure to the digital marketing content. The user, for instance, may send a message to “unsubscribe” from receipt of future digital marketing content (e.g., emails), mark the digital marketing content as “spam,” and so forth in an attempt to prevent further receipt of the digital marketing content.

Accordingly, dissemination control techniques of digital marketing content are described that address user fatigue. In an implementation, machine learning is used by a computing device to train a model using marketing data that describes user interactions with prior items of digital marketing content. The model is trained to determine whether users are “active” and thus receptive to receipt of digital marketing content or likely “fatigued” and are not receptive to receipt of digital marketing content. Other user states are also contemplated, such as whether a user is “at risk” of becoming fatigued and thus defines a state between active and fatigued.

Features are extracted and used as part of training the model to classify receptiveness of the users to receipt of digital marketing content. Examples of features include a number of items of prior digital marketing content received by the user, a number of the digital marketing content interactions by the user that are active (e.g., the user “clicked” a link as opposed to inactive and thus potentially merely viewed the link), whether the user interacted with functionality to cease receipt of the prior digital marketing content, or an amount of time since receipt of the prior digital marketing content by the user. A variety of machine learning techniques may be employed to train the model, such as through use of a Random Forest (RF), Hidden Markov Model (HMM), Support Vector Machine (SVM), Neural Network (NN), or Decision Tree (DT).

The model, once trained, is then used by a computing device to determine receptiveness of individual users to receipt of items of digital marketing content. The receptiveness of the individual users is indicated through use of a score. For example, user interaction data is first obtained that pertains to a user being evaluated. This data may be obtained from a variety of sources, such as a source of the training data, a service provider or marketer with which the user has interacted with, and so forth. The user interaction data is then examined by the trained model to generate a score indicating a likely degree of receptiveness of the individual users to receipt of additional digital marketing content.

The score is then used to control dissemination of the digital marketing content to the individual users. Segmentation, for instance, may be employed to assign the individual users to respective segments based on the scores. One such example is a fatigued segment in which users are fatigued and thus not receptive, at least currently, to receipt of additional items of digital marketing content. Another example is an active segment in which users are receptive to receipt of digital marketing content. Other segments may also be defined, such as for an “at risk” segment in which users, while currently receptive to additional digital marketing content, are at risk of becoming fatigued.

Based on the assignment of the users to respective segments, a determination is made as to a number of items of the digital marketing content to be disseminated to the users. This number, for instance, may be based such that the number of items are unlikely to cause the users to become fatigued. For users in the active or at risk segments, for instance, the number is defined for the users in these respective segments such that the users do not cross a threshold score that would cause the users to be considered fatigued and thus assigned to the fatigued segment. This determination may include a number of items as well as a time at which the items are to be sent, e.g., a dissemination frequency.

For users in the fatigued segment, the determination may also arrive at a number that would cause a score of the users to be considered active or at risk in the future. For example, the number may be combined with a temporal limitation (e.g., as a dissemination frequency) that is likely to cause scores of these users to be assigned to the active or at risk segments after receipt of this number of items over a defined amount of time. In this way, the fatigue control techniques described herein may prevent fatigue to users that are not currently fatigued as well as to help cure already fatigued users. As such, the techniques described herein may increase a likelihood of conversion by the users as well as increase a number of users that are receptive to the digital marketing content and thus subsequent conversions. Accordingly, this results in increased efficiency of digital marketing techniques as well as an improved user experience. Further discussion of these and other examples is included in the following.

In the following discussion, digital marketing content refers to content provided to users related to marketing activities performed, such as to increase awareness of and conversion of products or services made available by a service provider, e.g., via a website. Accordingly, digital marketing content may take a variety of forms, such as emails, advertisements included in webpages, webpages themselves, objects for display as part of virtual or augmented reality, and so forth.

An example environment is first described that may employ the dissemination control techniques described herein. Example procedures are then described which may be performed in the example environment as well as other environments. Consequently, performance of the example procedures is not limited to the example environment and the example environment is not limited to performance of the example procedures.

Example Environment

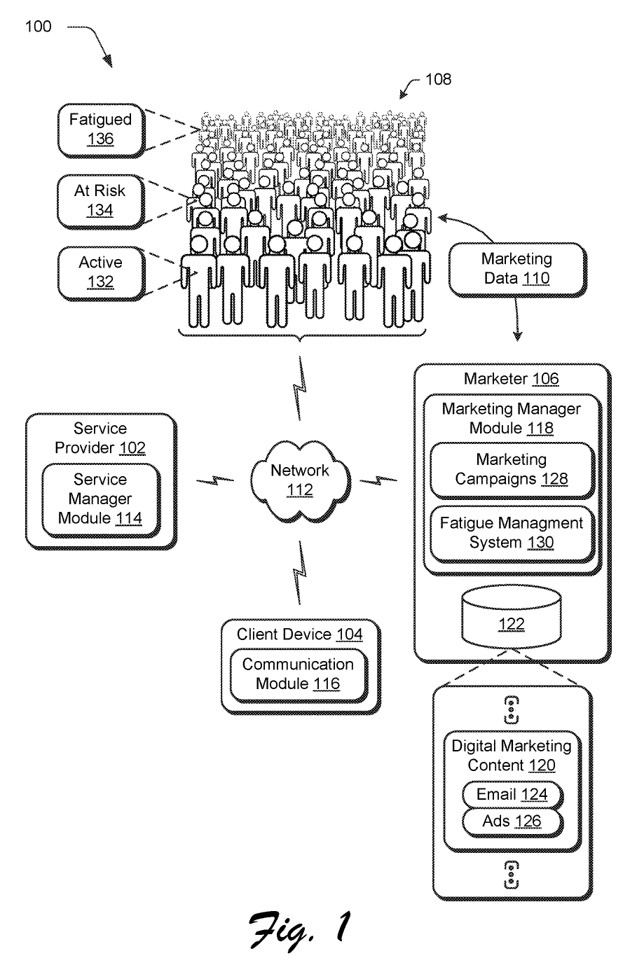

FIG. 1 is an illustration of an environment 100 in an example implementation that is operable to employ dissemination control techniques described herein. The illustrated environment 100 includes a service provider 102, client device 104, marketer 106, and source 108 of marketing data 110 that are communicatively coupled, one to another, via a network 112. Computing devices that are usable to implement the service provider 102, client device 104, marketer 106, and source 108 may be configured in a variety of ways.

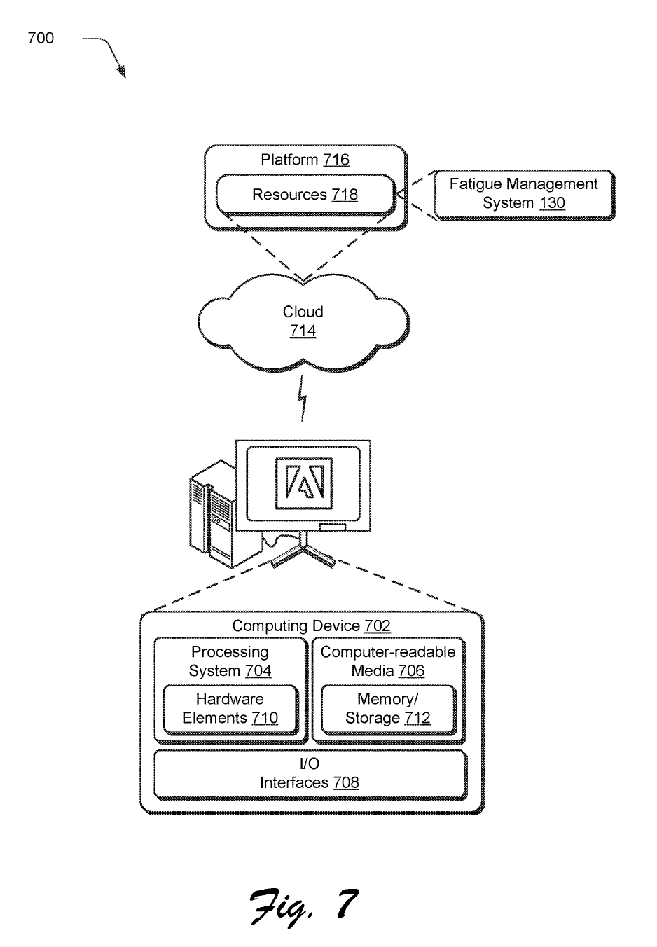

A computing device, for instance, may be configured as a desktop computer, a laptop computer, a mobile device (e.g., assuming a handheld configuration such as a tablet or mobile phone as illustrated), and so forth. Thus, the computing device may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers utilized by a business to perform operations “over the cloud” as further described in relation to FIG. 7.

The service provider 102 is illustrated as including a service manager module 114 that is representative of functionality to provide services accessible via a network 112 that are usable to make products or services available to consumers. The service manager module 114, for instance, may expose a website or other digital content functionality that is accessible via the network 112 by a communication module 116 of the client device 104. The communication module 116, for instance, may be configured as a browser, network-enabled application, and so on that obtains data from the service provider 102 via the network 112. This data is employed by the communication module 116 to enable a user of the client device 104 to communicate with the service provider 102 to obtain information about the products or services as well as purchase the products or services.

In order to promote the products or services, the service provider 102 may employ a marketer 106. Although functionality of the marketer 106 is illustrated as separate from the service provider 102, this functionality may also be incorporated as part of the service provider 102, further divided among other entities, and so forth. The marketer 106 includes a marketing manager module 118 that is representative of functionality to provide digital marketing content 120 for consumption by users, which is illustrated as stored in storage 122, in an attempt to encourage conversion of products or services of the service provider 102.

The digital marketing content 120 may assume a variety of forms, such as email 124, advertisements 126, and so forth. The digital marketing content 120, for instance, may be provided as part of a marketing campaign 128 to the sources 108 of the marketing data 110. The marketing data 110 may then be generated based on the provision of the digital marketing content 120 to describe which users received which items of digital marketing content 120 (e.g., from particular marketing campaigns) as well characteristics of the users. From this marketing data 110, the marketing manager module 118 may control which items of digital marketing content 120 are provided to a subsequent user, e.g., a user of client device 104, in order to increase a likelihood that the digital marketing content 120 is of interest to the subsequent user.

Part of the functionality usable to control provision of the digital marketing content 120 is represented as a fatigue management system 130. The fatigue management system 130 is implemented in hardware of at least one computing device to control dissemination of the digital marketing content 120. To do so, the fatigue management system 130 determines a receptiveness of users towards the digital marketing content 120. The fatigue management system 130, for instance, may determine whether a user that is to receive the digital marketing content is active 132 and therefore willing to receive digital marketing content 120. The fatigue management system 130 may also determine whether a user is at risk 124 and therefore willing to receive digital marketing content 120 but is at risk of becoming fatigued, or fatigued 136 and is not currently willing to receive the digital marketing content 120.

From this, the fatigue management system 130 determines a number of items of digital marketing content 120 to send to these individual users. The fatigue management system 130 may also determine when to send this content. In this way, the fatigue management system 130 may manage dissemination of the digital marketing content 120 such that users do not become fatigued in a manner that individually addresses the users. This may also be performed such that currently fatigued users are “cured” of this fatigue and thus willing to receive items of digital marketing content 120 at a later point in time. Further discussion of operation of the fatigue management system 130 is described in the following and shown in a corresponding figure.

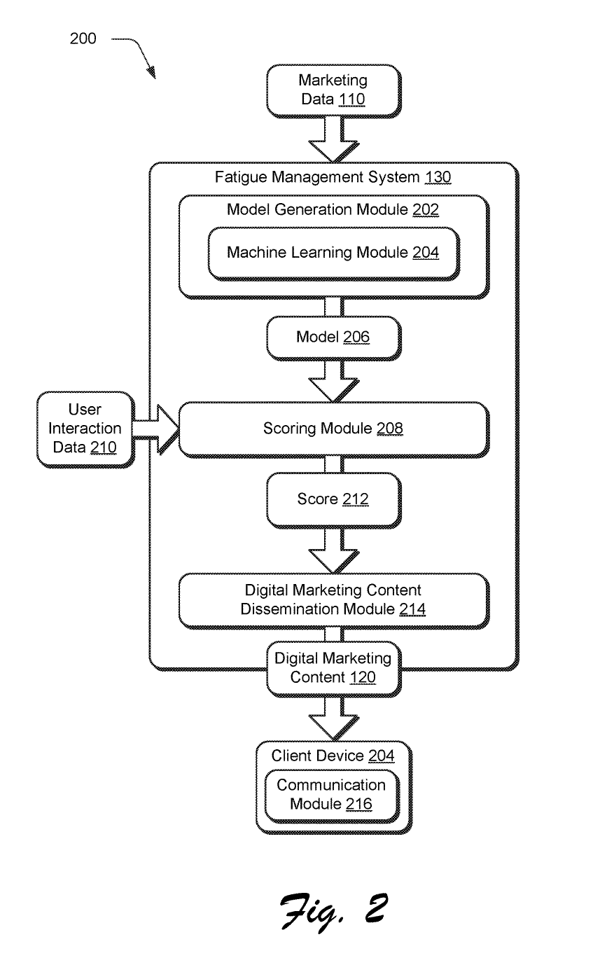

FIG. 2 depicts a system 200 in an example implementation showing the fatigue management system 130 in greater detail. The fatigue management system 130 includes a model generation module 202 that is implemented at least partially in hardware. The model generation module 202 includes a machine learning module 204 configured to generate a model 206 using machine learning. The model 206 is trained to identify receptiveness of users to receipt of digital marketing content 120.

To train the model 206, the model generation module 202 obtains marketing data 110 as described in FIG. 1. The marketing data 110 describes a variety of features involved as part of user interaction with prior digital marketing content. This includes which items of digital marketing content have been exposed to respective users, frequency of exposure, and amount of interaction of the users with the content (e.g., viewed or “clicked on”). Other examples include an amount of times a user has actively interacted with functionality to cause dissemination of digital marketing content to cease (e.g., unsubscribe, mark as spam), an amount of times a user has interacted with functionality contained within the digital marketing content (e.g., “clicked” a link in an email), characteristics of a user (e.g., gender, age, profession, geographic location), a number of items of digital content received in a set amount of time, and so forth.

The features are extracted from the described user interactions of the marketing data 110 and used to train the model 206 by the machine learning module 204. A variety of different machine learning techniques may be employed to perform this training. Examples of machine learning techniques include use of a Random Forest (RF), Hidden Markov Model (HMM), Support Vector Machine (SVM), Neural Network (NN), Decision Tree (DT), and so forth. In one or more implementations, this training is performed by the machine learning module 204 offline. Further, accuracy of the model 206 may be validated using a portion of the marketing data 110 that is “held back” from training the model 206 in order to ensure consistent operation of the model 206.

The model generation module 202 may also be configured to generate separate models 206 that are trained to identify particular segments of users. For example, the model generation module 204 may train a fatigued model that is configured to identify users that are potentially fatigued and not receptive to receipt of additional items of digital marketing content 120 at this time. Likewise, the model generation module 204 may train an active model that is configured to identify users that are active and thus are receptive to receipt of digital marketing content 120 at this time. Other examples are also contemplated, such as to train an “at risk” model to identify users that are currently receptive to receipt of additional items of digital marketing content 120 but are at risk of becoming fatigued.

Other configurations of models are also contemplated, such as through use of a single model that is usable to generate a single score that is indicative of which of the segments a user is to be assigned. Thus, regardless of whether a single model 206 is generated or a plurality of models are generated, these models 206 may be employed to generate a score indicating relative receptiveness of users to receipt of additional digital marketing content as further described below.

The model 206 is then obtained by a scoring module 208. The scoring module 208 is implemented at least partially in hardware to employ the model 206 to process user interaction data 210 to arrive at a score 212 indicating receptiveness of a corresponding user to receipt of digital marketing content 120. An example implementation of operation of the scoring module 208 is described in the following and shown in a corresponding figure.

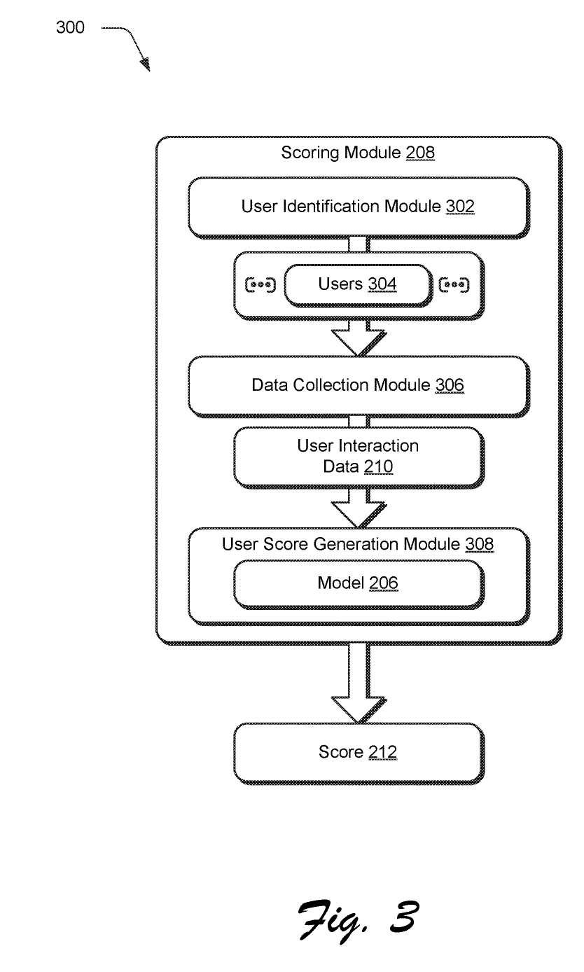

FIG. 3 depicts a system 300 in an example implementation showing operation of the scoring module 208 of FIG. 2 in greater detail. The scoring module 208 is illustrated as including a user identification module 302 that is implemented at least partially in hardware of a computing device 102 to identify users 304 that are to be evaluated for fatigue to control dissemination of digital marketing content to these users 304. The user identification module 302, for instance, may output a user interface via which a marketer may identify users or groups of users for evaluation. In another instance, the user identification module 302 identifies a subset of users from a user pool at regular intervals.

The identification of the users 304 is then provided to a data collection module 306. The data collection module 306 is implemented at least partially in hardware to collect user interaction data 210 for the identified users 304. The user interaction data 210, for instance, may describe previous digital marketing content 120 sent by the marketer 106 or other marketers, by the service provider 102, or elsewhere. Accordingly, user interaction data 210 may be obtained from the marketing data 110 of the marketer 106, from a service provider 102 (e.g., a website provider), and even a client device 104 of the identified user, e.g., via a module that sends this data by monitoring local user interaction. Thus, the collected user interaction data 210 describes past behavior of the user and exposure of the user to digital marketing content.

The user interaction data 210 is then provided to a user score generation module 308. The user score generation module 308 is implemented at least partially in hardware to generate a score 212 indicating receptiveness of the users 304 to subsequent digital marketing content 120. To do so, the user score generation module 308 employs the model 206 trained by the model generation module 202 using machine learning as previously described.

First, features are extracted from the user interaction data 210. Examples of these features include the same as or similar features to those used to train the model 206. The features, for instance, may include which items of digital marketing content have been exposed to respective users, frequency of exposure, and amount of interaction of the users with the content (e.g., viewed or “clicked on”). Other instances include an amount of times a user has actively interacted with functionality to cause dissemination of digital marketing content to cease (e.g., unsubscribe, mark as spam), an amount of times a user has interacted with functionality contained within the digital marketing content (e.g., “clicked” a link in an email), characteristics of a user (e.g., gender, age, profession, geographic location), a number of items of digital content received in a set amount of time, and so forth.

The extracted features are then processed by the model 206 to generate a score 212 that defines a relative receptiveness of an individual user to receipt to subsequent digital marketing content. In this way, the score 212 may be used as a basis to control how many items of digital marketing content 120 are disseminated to that user as well as when those items are disseminated, further description of which is included in the following discussion.

Returning again to FIG. 2, the score 212 is then provided to a digital marketing content dissemination module 214. The digital marketing content dissemination module 214 is implemented at least partially in hardware to control dissemination of the digital market content 120 based on the score 212 of an individual user that corresponds to the user interaction data 210. Dissemination is used to generate the score 212. In this way, receptiveness of individual users to digital marketing content 120 may be used to control dissemination, which is not possible using conventional techniques.

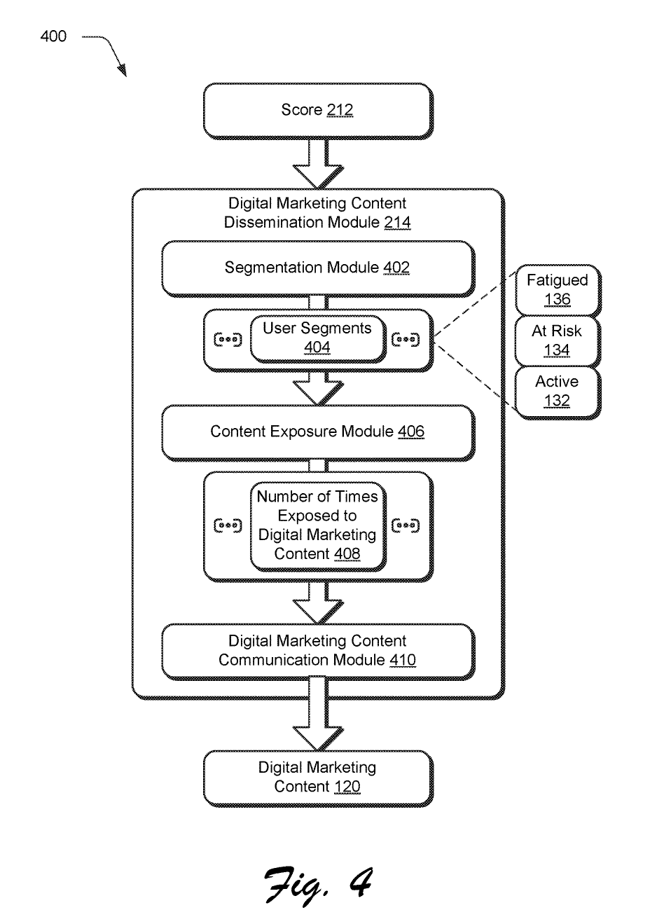

FIG. 4 depicts as system 400 in an example implementation showing operation of the digital marketing content dissemination module 214 in greater detail. In an implementation, a segmentation module 402 is employed to assign the score 212 to a respective one of a plurality of user segments 404. The user segments 404 are then used to control subsequent dissemination.

The segmentation module 402, for instance, may employ predefined ranges and thresholds of values of the scores 212. In one example, higher numerical values indicate increasing higher relative amounts of fatigue. Accordingly, the user segments 414 are used to assign to scores 212 having amounts below a first threshold to an active 132 segment as these users exhibit relatively low amounts of fatigue. Users having scores 212 between the first threshold and a second threshold are assigned an “at risk” 134 segment of becoming fatigued. Users having scores 212 beyond the second threshold to a fatigued 136 segment as being fatigued. In another example, user segments 404 are not used but rather control of dissemination is based directly on the value of the score 212, e.g., such that control of a number of items to be disseminated may change within what otherwise would be a single segment in the example above.

Continuing with the segment example, a content exposure module 406 obtains the assignments to the user segments 404 from the segmentation module 402. The content exposure module 406 is implemented at least partially in hardware to control a number of times the individual users are exposed to digital marketing content 408 (e.g., over a defined amount of time) in a manner that addresses fatigue. The content exposure module 406, for instance, may determine a number of messages that may be sent to a corresponding user (e.g., over a defined amount of time) such that the user remains in an active 132 or even at risk 134 segment and thus does not cross into the fatigued segment. For users in the fatigued 136 segment, the content exposure module 406 determines a number of times the users may be exposed to digital marketing content 408 over a defined amount of time to causes assignment of a respective score 212 to the at risk 134 or active 132 segments. A digital marketing content communication module 410 is then employed to control communication of the digital marketing content 120 based on the determined number and timing thereof. In this way, the digital marketing content dissemination module 214 may control dissemination of the digital marketing content 120 such that users that are not fatigued (e.g., assigned to the active 132 or at risk 134 segments) do not become fatigued.

Additionally, the digital marketing content dissemination module 214 may also act to cure currently fatigued users. In at least one implementation, when a non-monotonic approach (i.e., is not “by user) is employed for classifying the scores 212 into the segments, there may be multiple minima, e.g., a minimal number of messages to be sent to prevent fatigue. In such an instance, the lowest value of the number of messages for which the minima is obtained is chosen as the optimal number of messages to be sent for users assigned to that segment.

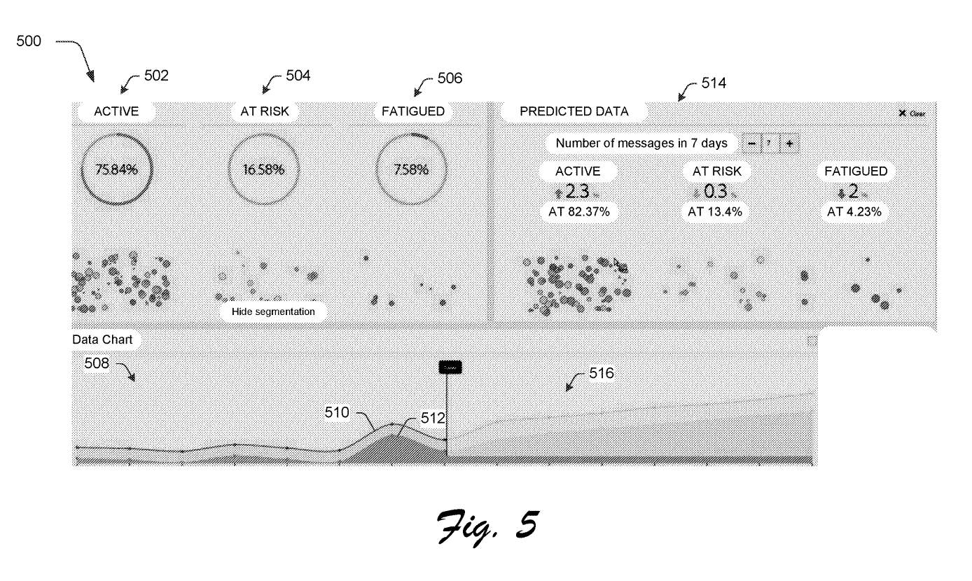

FIG. 5 depicts an example of a user interface 500 output by the fatigue management system 130. The user interface 500 is usable by a marketer or other user to obtain an insight into user fatigue and control a number of messages based on this insight. For example, the user interface 500 includes indications of active 502, at risk 504, and fatigued 506 segments of users as calculated from user interaction data 210 of FIG. 2. The user interface 500 also includes a portion 508 graphically representing the user interaction data used to make these determinations, e.g., an open rate 510 (e.g., a number of items of digital marketing content 120 opened) and a click rate 512 (e.g., a number of times functionality within the digital marketing content 120 is selected).

The user interface 500 also includes a portion 514 that is configured to accept inputs to specify a number of exposures of digital marketing content 120 over a defined amount of time and view an output of a prediction of an effect of that number on respective segments. For example, a user may input “seven” messages are to be sent over seven days. An effect of this exposure is illustrated as increasing a number of users in the active segment by 2.3%, the number of users in the at risk segment as dropping by 0.3%, and a number of users assigned to the fatigued segment as dropping by 2%. A prediction 516 is also included in the portion 508 showing the data to illustrate a likely effect on open and click rates 510, 512. In this way, the user may readily gain insight into a likely effect of dissemination of the digital marketing content 120 on potential fatigue of these users. A variety of other examples are also contemplated as further described in relation to the following procedures.

Example Procedures

The following discussion describes dissemination control techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

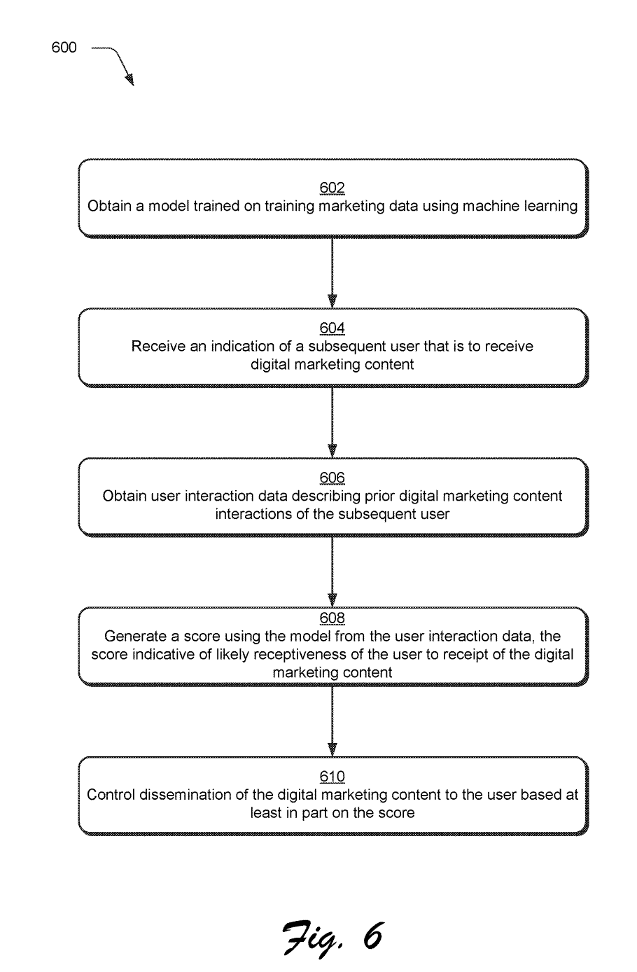

FIG. 6 is a flow diagram depicting a procedure in an example implementation in which dissemination control techniques of digital marketing content address potential user fatigue. A model is obtained that is trained on training marketing data using machine learning (block 602). The marketing data describes user interactions with digital marketing content, e.g., features of user interactions such as “clicks,” how many times items of digital marketing are exposed to users, a number of times the users have unsubscribed to digital marketing content, and so forth.

An indication is also received of a subsequent user that is to receive the digital marketing content (block 604), such as from interaction of a marketer with a user interface, selection of a subset of users from a pool of users that are to receive digital marketing content, and so forth. User interaction data is then obtained that describes prior digital marketing content interactions of the subsequent user (block 606). The user interaction data, for instance, may include features that are similar to features of the marketing data used to train the model as described above.

A score is generated by processing the user interaction data using the model (block 608). The score is indicative of likely receptiveness of the user to receipt of the digital marketing content. The score, for instance, may be used to assign the user to a fatigued segment in which the user is not receptive at this point in time to receipt of items of digital marketing content. The score may also be used to assign the user to an active segment in which the user is receptive to receipt of items of digital marketing content. Other segments are also contemplated, such as an “at risk” segment in which the user is currently receptive to receipt of digital marketing content but is in danger of becoming fatigued.

Dissemination is controlled of the digital marketing content to the user based at least in part on the score (block 610). Continuing with the segmentation example, a number of items of the digital marketing content may be determined that is likely to cause the subsequent user, after receipt of this content, to remain in the active or at risk segment. Similarity, the number of items of the digital marketing content may be determined that is likely to cause the subsequent user in the fatigued segment to transition to the active or at risk segments. In this way, the dissemination techniques may be employed to reduce a likelihood of users becoming fatigued by receipt of the digital marketing content and even cure users that are fatigued.

Example System and Device

FIG. 7 illustrates an example system generally at 700 that includes an example computing device 702 that is representative of one or more computing systems and/or devices that may implement the various techniques described herein. This is illustrated through inclusion of the causal impact system 130. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to control dissemination of digital marketing content, a method implemented by a computing device, the method comprising:
obtaining, by the at least one computing device, a model trained on training marketing data using machine learning to indicative user receptiveness to digital marketing content through use of a score;
receiving, by the at least one computing device, an indication of a subsequent user that is to receive the digital marketing content;
obtaining, by the at least one computing device, user interaction data describing prior digital marketing content interactions of the subsequent user;
generating, by the at least one computing device, the score using the model from the user interaction data, the score indicative of likely receptiveness of the subsequent user to receipt of a respective number of items of the digital marketing content; and
controlling, by the at least one computing device, dissemination of the respective number of items of the digital marketing content to the user based at least in part on the score.

2. A method as described in claim 1, wherein the model is trained using machine learning through use of a Random Forest (RF), Hidden Markov Model (HMM), Support Vector Machine (SVM), Neural Network (NN), or Decision Tree (DT).

3. A method as described in claim 1, wherein generating of the score is based on a plurality of features taken from the user interaction data, the plurality of features including:
a number of items of prior digital marketing content received by the user;
a number of the digital marketing content interactions by the user that are active;
whether the user interacted with functionality to cease receipt of the prior digital marketing content; or
an amount of time since receipt of the prior digital marketing content by the user.

4. A method as described in claim 1, further comprising assigning, by the at least one computing device, the user to a respective segment of a plurality of segments based on the score and wherein the controlling is based on the number of items to be sent that are identified as unlikely to cause the user to become fatigued by receipt of the digital marketing content, the number of items based on the assigned segment.

5. A method as described in claim 4, wherein the plurality of segments include:
a fatigued segment having respective said users that are fatigued and thus are not receptive to the digital marketing content; and
an active segment having respective said user that are not fatigued and thus are receptive to the digital marketing content.

6. A method as described in claim 5, wherein the number of items of the digital marketing content for the fatigued segment causes subsequent said scores of the respective said users that are generated based at least in part on receipt of the number of items of the digital marketing content to be assigned to the active segment.

7. A method as described in claim 5, wherein the number of items of the digital marketing content for the active segment causes subsequent said scores of the respective said users that are generated based at least in part on receipt of the number of items of the digital marketing content to remain assigned to the active segment.

8. A method as described in claim 1, wherein the training marketing data describes user interactions with prior digital marketing content.

9. In a digital medium environment to control dissemination of digital marketing content, a method implemented by a computing device, the method comprising:
generating, by the at least one computing device, a score for each of a plurality of users, the score indicative of receptiveness of a respective said user to receipt of digital marketing content;
assigning, by the at least one computing device, each of the plurality of users to a respective segment of a plurality of segments, the assigning based on a respective said score;
identifying, by the at least one computing device, a number of items of the digital marketing content that the users of respective ones of the plurality of segments are receptive to receiving without becoming fatigued by receipt of the number of items of the digital marketing content; and
disseminating the identified number of items of the digital marketing content to the users in at least one of the plurality of segments.

10. A method as described in claim 9, wherein the fatigue of the users in the respective said segments is likely to result in receipt of a user indication to unsubscribe or block receipt of the digital marketing content.

11. A method as described in claim 9, wherein the generating of the score includes using a model trained using machine learning on training marketing data, the training marketing data describing user interactions with prior digital marketing content.

12. A method as described in claim 9, wherein the plurality of segments include:
a fatigued segment having respective said users that are fatigued; and
an active segment having respective said user that are not fatigued.

13. A method as described in claim 12, wherein the identifying of the number of items of the digital marketing content for the respective said users in the fatigued segment causes subsequent said scores of the respective said users that are generated based at least in part on receipt of the number of items of the digital marketing content to be assigned to the active segment.

14. A method as described in claim 12, wherein the identifying of the number of items of the digital marketing content for the respective said users in the active segment causes subsequent said scores of the respective said users that are generated based at least in part on receipt of the number of items of the digital marketing content to remain assigned to the active segment.

15. In a digital medium environment to control dissemination of digital marketing content, a system comprising:
a model generation module implemented at least partially in hardware to train a module using machine learning on training data;
a scoring module implemented at least partially in hardware to:
obtain user interaction data describing past digital marketing content interactions of a subsequent user that is to receive the digital marketing content; and
generate a score from the user interaction data using the model, the score indicative of likely receptiveness of the user to receipt of a number of items of the digital marketing content; and
a digital marketing content dissemination module implemented at least partially in hardware to control dissemination of the digital marketing content to the user based at least in part on the score.

16. A system as described in claim 15, wherein the digital marketing content dissemination module is further configured to assign the user to a respective segment of a plurality of segments based on the score and control the dissemination based on the number of items to be sent that are identified as unlikely to cause the user to become fatigued by receipt of the digital marketing content, the number of items based on the assigned segment.

17. A system as described in claim 16, wherein the plurality of segments include:
a fatigued segment having respective said users that are fatigued and thus are not receptive to the digital marketing content; and
an active segment having respective said user that are not fatigued and thus are receptive to the digital marketing content.

18. A system as described in claim 17, wherein the number of items of the digital marketing content for the fatigued segment causes subsequent said scores of the respective said users that are generated based at least in part on receipt of the number of items of the digital marketing content to be assigned to the active segment.

19. A system as described in claim 17, wherein the number of items of the digital marketing content for the active segment causes subsequent said scores of the respective said users that are generated based at least in part on receipt of the number of items of the digital marketing content to remain assigned to the active segment.

20. A system as described in claim 15, wherein the scoring module is configured to generate the score based on a plurality of features taken from the user interaction data, the plurality of features including:
a number of items of prior digital marketing content received by the user;
a number of the digital marketing content interactions by the user that are active;
whether the user interacted with functionality to cease receipt of the prior digital marketing content; or
an amount of time since receipt of the prior digital marketing content by the user.
